(19) United States
(12) Patent Application Publication
(10) Pub. No.: US 2021/0155796 A1
(43) Pub. Date: May 27, 2021

(54) POLY(LACTIC ACID)-BASED MATERIALS BY METHOD UTILIZING MELT STRETCHING AND COLD CRYSTALLIZATION

(71) Applicant: Shi-Qing Wang, Streetsboro, OH (US)

(72) Inventor: Shi-Qing Wang, Streetsboro, OH (US)

(21) Appl. No.: 17/027,990

(22) Filed: Sep. 22, 2020

Related U.S. Application Data
(60) Provisional application No. 62/939,274, filed on Nov. 22, 2019.
(60) Provisional application No. 62/944,740, filed on Dec. 6, 2019.

(51) Int. Cl. C08L 67/04; B29C 49/00

(52) U.S. Cl. CPC C08L 67/04; B29K 2067/046; B29C 49/0005

(57) ABSTRACT

A process for producing poly(lactic acid)-based material includes a melt stretching step including melt stretching amorphous poly(lactic acid) resin at a melt stretch temperature Tₘₛ, wherein the amorphous poly(lactic acid) resin is capable of crystallization, and wherein the Tₘₛ is greater than the glass transition temperature T_{g} of the amorphous poly(lactic acid) resin and less than the crystallization temperature T_{c} of the amorphous poly(lactic acid) resin, thus providing a melt stretched poly(lactic acid); and a crystallization step including providing the melt stretched poly(lactic acid) at a cold crystallization temperature T_{cc} of greater than the glass transition temperature T_{g} of the amorphous poly(lactic acid) resin and less than the crystallization temperature T_{c} of the amorphous poly(lactic acid) resin, and wherein the melt stretched poly(lactic acid) is maintained at the cold crystallization temperature T_{cc} for a sufficient time t_{cc} to allow for cold crystallization.

### CROSS-REFERENCE TO RELATED APPLICATIONS

This application claims the benefit of U.S. Provisional Application No. 62/939,274, filed on Nov. 22, 2019, and U.S. Provisional Application No. 62/944,740, filed on Dec. 6, 2019, which are each incorporated herein by reference.

### STATEMENT REGARDING FEDERALLY SPONSORED RESEARCH OR DEVELOPMENT

This invention was made with government support under DMR-1609977 and DMR-1905870 awarded by National Science Foundation. The government has certain rights in the invention.

### FIELD OF THE INVENTION

Embodiments of the present invention relate to improved poly(lactic acid)-based materials. Other embodiments of the present invention relate to methods of making the poly(lactic acid)-based materials utilizing melt stretching and cold crystallization.

### BACKGROUND OF THE INVENTION

Because of the rather poor mechanical properties, poly(lactic acid) (PLA), which may also be referred to as poly(lactide), has yet to fully fulfill its potential as an advanced biodegradable non-petroleum-based material for replacing fossil-based polyesters, such as polyethylene terephthalate (PET). As such, the commercial annual production of PLA pales in comparison to that of PET. Applications of PLA have been restricted to a few specialized areas, such as films and fibers.

Because of its low glass transition temperature T_{g} of about 60° C., PLA has low thermal resistance in its amorphous form and turns brittle rapidly upon physical aging. This occurs readily during several hours of storage at room temperature (RT), based on the low T_{g}.

Polymer crystallization is a common mechanism for improving mechanical reinforcement in certain polymers, such as class A semicrystalline polymers whose T_{g} is well below RT, such as polyethylene (PE) and polypropylene (PP). Other semicrystalline polymers with T_{g} well above RT belong to class B. PLA, PET, and isotactic and syndiotactic polystyrene are in class B. Class B polymers are typically brittle at RT. And, upon introducing crystallization to PLA in an effort to improve thermal stability, PLA is opaque and brittle, even without physical aging.

Thus, until the shortcomings are solved relative to the poor mechanical performance, low thermal resistance, and lack of optical clarity, PLA would not be able to significantly replace PET. There remains a need in the art for the production of ductile, clear, and heat-resistant PLA materials.

### SUMMARY OF THE INVENTION

An embodiment of the present invention provides a method for producing poly(lactic acid)-based material comprising: providing an amorphous poly(lactic acid) resin having a glass transition temperature T_{g} and a crystallization temperature T_{c}; a melt stretching step including melt stretching amorphous poly(lactic acid) resin at a melt stretch temperature Tₘₛ, wherein the amorphous poly(lactic acid) resin is capable of crystallization, and wherein the Tₘₛ is greater than the glass transition temperature T_{g} of the amorphous poly(lactic acid) resin and less than the crystallization temperature T_{c} of the amorphous poly(lactic acid) resin, thus providing a melt stretched poly(lactic acid); and a crystallization step including providing the melt stretched poly(lactic acid) at a cold crystallization temperature T_{cc} of greater than the glass transition temperature T_{g} of the amorphous poly(lactic acid) resin and less than the crystallization temperature T_{c} of the amorphous poly(lactic acid) resin, and wherein the melt stretched poly(lactic acid) is at the cold crystallization temperature T_{cc} for a sufficient time t_{cc} to allow for cold crystallization of the melt stretched poly(lactic acid)

Another embodiment of the present invention provides a method as in any embodiment above, wherein the amorphous poly(lactic acid) resin is a resin selected from the group consisting of poly(L-lactic acid) (PLLA) resin, and resins of copolymers of PLLA and poly(D,L-lactic acid) (PDLLA), and mixtures thereof.

Another embodiment of the present invention provides a method as in any embodiment above, wherein the amorphous poly(lactic acid) resin includes poly(lactic acid) at an average molecular weight selected from the group consisting of greater than 35 kDa, greater than 50 kDa, greater than 75 kDa, greater than 100 kDa, and greater than 120 kDa.

Another embodiment of the present invention provides a method as in any embodiment above, wherein the amorphous poly(lactic acid) resin includes PLLA at an average molecular weight of from 50 kDa to 300 kDa.

Another embodiment of the present invention provides a method as in any embodiment above, wherein the amorphous poly(lactic acid) resin includes PLLA at an average molecular weight of from 100 kDa to 300 kDa.

Another embodiment of the present invention provides a method as in any embodiment above, wherein, in the melt stretching step, the amorphous poly(lactic acid) resin is stretched uniaxially.

Another embodiment of the present invention provides a method as in any embodiment above, wherein, in the uniaxial melt stretching step, the amorphous poly(lactic acid) resin is stretched to a stretch ratio Xₘₛ selected from the group consisting of 2 or greater, 2.25 or greater, 2.5 or greater, and 3 or greater.

Another embodiment of the present invention provides a method as in any embodiment above, wherein, in the melt stretching step, the amorphous poly(lactic acid) resin is stretched biaxially.

Another embodiment of the present invention provides a method as in any embodiment above, wherein, in the biaxial melt stretching step, the amorphous poly(lactic acid) resin is stretched to a stretch ratio Xₘₛ selected from the group consisting of 1.5×1.5 or greater, 2×2 or greater, 2.5×2.5 or greater, and 3×3 or greater.

Another embodiment of the present invention provides a method as in any embodiment above, wherein, in the melting step, the amorphous poly(lactic acid) resin is stretched at a rate at least ten times the dominant chain relaxation rate to achieve molecular stretching.

Another embodiment of the present invention provides a method as in any embodiment above, wherein Tₘₛ is from 60° C. or more to 105° C. or less.

Another embodiment of the present invention provides a method as in any embodiment above, wherein Tₘₛ is from 70° C. or more to 100° C. or less.

Another embodiment of the present invention provides a method as in any embodiment above, wherein Tₘₛ is from 70° C. or more to 90° C. or less.

Another embodiment of the present invention provides a method as in any embodiment above, wherein T_{CC} is from 65° C. or more to 105° C. or less.

Another embodiment of the present invention provides a method as in any embodiment above, wherein T_{CC} is from 70° C. or more to ° C. 100 or less.

Another embodiment of the present invention provides a method as in any embodiment above, wherein T_{CC} is from 70° C. or more to 90° C. or less.

Another embodiment of the present invention provides a method as in any embodiment above, wherein t_{CC} is 2 minutes or more.

Another embodiment of the present invention provides a method as in any embodiment above, wherein the step of crystallization includes holding the melt stretched poly(lactic acid) in a stretched state at the cold crystallization temperature T_{CC}.

Another embodiment of the present invention provides a method as in any embodiment above, further comprising a storage quenching step after said melt stretching step and before said crystallization step, the storage quenching step including: quenching the melt stretched poly(lactic acid) from Tₘₛ to a quench temperature T_{q} below the glass transition temperature T_{g} of the amorphous poly(lactic acid) resin within a predetermined amount of quench time to thereby form a quenched poly(lactic acid); and storing the quenched poly(lactic acid) of said storage quenching step for a predetermined amount of storage time prior to carrying out said crystallization step.

Another embodiment of the present invention provides a method as in any embodiment above, wherein the step of quenching includes holding the melt stretched poly(lactic acid) in a stretched state at the quench temperature T_{q}.

Another embodiment of the present invention provides a method as in any embodiment above, wherein the predetermined amount of quench time is 2 minutes or less.

Another embodiment of the present invention provides a method as in any embodiment above, wherein the predetermined amount of storage time is 1 month or more.

Another embodiment of the present invention provides a method as in any embodiment above, wherein T_{q} is room temperature.

Another embodiment of the present invention provides a method as in any embodiment above, further comprising an amorphizing step, prior to said melt stretching step, the amorphizing step including: heating poly(lactic acid) resin above its melting temperature Tₘ to create a molten poly(lactic acid); and quenching the molten poly(lactic acid) to an amorphizing temperature Tₐ below the glass transition temperature T_{g} of the poly(lactic acid) resin to avoid crystallization and to maintain an amorphous state.

Another embodiment of the present invention provides a method as in any embodiment above, wherein, in said step of heating the poly(lactic acid) resin, the poly(lactic acid) resin is heated to a temperature of from 170 to 210° C.

Another embodiment of the present invention provides a method as in any embodiment above, wherein, in said step of quenching the molten poly(lactic acid), the molten poly(lactic acid) is quenched down to room temperature within 1 minute or less.

Another embodiment of the present invention provides a poly(lactic acid) material made by the method of any embodiment above.

Another embodiment of the present invention provides a poly(lactic acid) material of any embodiment above, wherein the poly(lactic acid) material includes nano-confined crystalline form.

Another embodiment of the present invention provides a poly(lactic acid) material of any embodiment above, wherein the poly(lactic acid) material includes a heat distortion temperature (HDT) above 120° C.

Another embodiment of the present invention provides a poly(lactic acid) material of any embodiment above, wherein the poly(lactic acid) material shows indiscernible change in its length after 1 hour of annealing at 120° C.

Another embodiment of the present invention provides a poly(lactic acid) material of any embodiment above, wherein the poly(lactic acid) material is optically clear.

Another embodiment of the present invention provides a poly(lactic acid) material of any embodiment above, wherein the poly(lactic acid) material has a Young's modulus up to 250 MPa.

### DETAILED DESCRIPTION OF ILLUSTRATIVE EMBODIMENTS

Embodiments of the present invention relate to improved poly(lactic acid)-based materials. Other embodiments of the present invention relate to methods of making the poly(lactic acid)-based material utilizing melt stretching and cold crystallization. The method includes a melt stretching step including melt stretching the amorphous poly(lactic acid) resin, which is capable of crystallization, at a melt stretch temperature Tₘₛ. The Tₘₛ is greater than the glass transition temperature T_{g} of the amorphous poly(lactic acid) resin and less than the crystallization temperature T_{c} of the amorphous poly(lactic acid) resin. The method further includes a crystallization step including providing the melt stretched poly(lactic acid) at a cold crystallization temperature T_{cc} of greater than the glass transition temperature T_{g} of the amorphous poly(lactic acid) resin and less than the crystallization temperature T_{c} of the amorphous poly(lactic acid) resin. The crystallization step may include holding the melt stretched poly(lactic acid) in a stretched state and at the cold crystallization temperature T_{cc}. If T_{cc} is low enough, cold crystallization can occur before considerable sample contraction such that the holding may not be required. The crystallization step generally includes maintaining the melt stretched poly(lactic acid) at the cold crystallization temperature T_{cc} for a sufficient time t_{cc} to allow for cold crystallization of the melt stretched poly(lactic acid). The method produces an improved poly(lactic acid)-based material, which may also be referred to as a cold crystallized, melt stretched poly(lactic acid)-based material (cc-ms-PLA). Advantageously, the crystallization of the poly(lactic acid)-based material is modified in a manner such that the crystallization thereof is no longer detrimental to ductility. Moreover, the crystallization is still present in a manner to provide adequate thermomechanical stability to the poly(lactic acid)-based material. The poly(lactic acid)-based material is ductile, clear, and heat-resistant.

The methods disclosed herein generally include a first step of providing an amorphous poly(lactic acid) resin. The amorphous poly(lactic acid) resin may be selected from the group consisting of poly(L-lactic acid) (PLLA) resin, and resins of copolymers of PLLA and poly(D,L-lactic acid) (PDLLA), and mixtures thereof.

As generally known to the skilled person, the amorphous poly(lactic acid) resin will have a glass transition temperature T_{g} and a crystallization temperature T_{c}. Certain of the method steps described herein utilize steps at temperatures relative to these glass transition temperature T_{g} and crystallization temperature T_{c}.

The amorphous poly(lactic acid) resin may be described based on the average molecular weight of poly(lactic acid) included therein. In one or more embodiments, the amorphous poly(lactic acid) resin may include poly(lactic acid) at an average molecular weight of greater than 35 kDa, in other embodiments, greater than 50 kDa, in other embodiments, greater than 75 kDa, in other embodiments, greater than 100 kDa, and in other embodiments, greater than 120 kDa.

In one or more embodiments, the amorphous poly(lactic acid) resin may include poly(lactic acid) (PLA) at an average molecular weight of from 50 kDa to 300 kDa, in other embodiments, from 100 kDa to 300 kDa, in other embodiments, from 100 kDa to 250 kDa, and in other embodiments, from 150 kDa to 250 kDa.

In one or more embodiments, the amorphous poly(lactic acid) resin may include poly(L-lactic acid) (PLLA) at an average molecular weight of greater than 35 kDa, in other embodiments, greater than 50 kDa, in other embodiments, greater than 75 kDa, in other embodiments, greater than 100 kDa, and in other embodiments, greater than 120 kDa.

In one or more embodiments, the amorphous poly(lactic acid) resin may include poly(L-lactic acid) (PLLA) at an average molecular weight of from 50 kDa to 300 kDa, in other embodiments, from 100 kDa to 300 kDa, in other embodiments, from 100 kDa to 250 kDa, and in other embodiments, from 150 kDa to 250 kDa.

The methods disclosed herein generally include a step of melt stretching after the step of providing an amorphous poly(lactic acid) resin. The melt stretching step generally includes melt stretching the amorphous poly(lactic acid) resin at a melt stretch temperature Tₘₛ. The amorphous poly(lactic acid) resin is capable of being crystallized. The Tₘₛ is greater than the glass transition temperature T_{g} of the amorphous poly(lactic acid) resin and less than the crystallization temperature T_{c} of the amorphous poly(lactic acid) resin, thus providing a melt stretched poly(lactic acid).

In one or more embodiments, the melt stretch temperature Tₘₛ is from 60° C. or more to 105° C. or less, in other embodiments, from 70° C. or more to 100° C. or less, and in other embodiments, from 70° C. or more to 90° C. or less.

The melt stretching step may be described based on a stretch ratio, or extension ratio, of the amorphous poly(lactic acid) resin. Stretch ratio is generally a measure of the extensional or normal strain of a material. This can be defined at either the undeformed configuration or the deformed configuration. Stretch ratio is generally defined as the ratio between a final length t after the stretch and an initial length L of the material.

The melt stretching step may include either uniaxially melt stretching or biaxially melt stretching the amorphous poly(lactic acid) resin.

In embodiments of the present invention where the amorphous poly(lactic acid) resin is uniaxially melt stretched, the amorphous poly(lactic acid) resin may be stretched to a stretch ratio λₘₛ of 2 or greater, in other embodiments, 2.25 or greater, in other embodiments, 2.5 or greater, in other embodiments, and in other embodiments 3 or greater.

In embodiments of the present invention where the amorphous poly(lactic acid) resin is biaxially melt stretched, the amorphous poly(lactic acid) resin may be stretched to a stretch ratio λₘₛ of 1.5×1.5 or greater, in other embodiments, 2×2 or greater, in other embodiments, 2.5×2.5 or greater, in other embodiments, and in other embodiments, 3×3 or greater.

The melt stretching step may include stretching the amorphous poly(lactic acid) resin at a certain rate. In one or more embodiments, the amorphous poly(lactic acid) resin is stretched at a rate of at least five times, in other embodiments, at least ten times, and in other embodiments, at least fifteen times, the dominant chain relaxation rate. The stretching rate is generally high enough to achieve molecular stretching.

The methods disclosed herein generally include a step of crystallization, which may be referred to as cold crystallization, after the step of melt stretching. The crystallization step includes providing, which may include adjusting the temperature, the melt stretched poly(lactic acid) at a cold crystallization temperature T_{cc} of greater than the glass transition temperature T_{g} of the amorphous poly(lactic acid) resin and less than the crystallization temperature T_{c} of the amorphous poly(lactic acid) resin. As suggested above, the crystallization step may include holding the melt stretched poly(lactic acid) in a stretched state and at the cold crystallization temperature T_{cc}. Though, if T_{cc} is low enough, cold crystallization can occur before considerable sample contraction such that the holding may not be required. The crystallization step generally includes maintaining the melt stretched poly(lactic acid) for a sufficient time t_{cc} at the cold crystallization temperature T_{cc} to allow for cold crystallization.

In one or more embodiments, the cold crystallization temperature T_{cc} may be in a range of from 65° C. or more to 105° C. or less, in other embodiments, from 70° C. or more to ° C. 100 or less, and in other embodiments, from 70° C. or more to 90° C. or less.

In one or more embodiments, the sufficient time t_{cc} at the cold crystallization temperature T_{cc} may be 2 minutes or more, in other embodiments, 4 minutes or more, in other embodiments, 6 minutes or more, in other embodiments, 10 minutes or more, and in other embodiments, 15 minutes or more.

The methods disclosed herein may include a storage quenching step. Where present, the storage quenching step generally occurs after the step of melt stretching and before the crystallization step.

The storage quenching step generally includes quenching the melt stretched poly(lactic acid) from the melt stretch temperature Tₘₛ to a quench temperature T_{q}. The quench temperature T_{q} may be below the glass transition temperature T_{g} of the amorphous poly(lactic acid) resin. The quenching to the quench temperature T_{q} occurs within a predetermined amount of quench time and forms a quenched poly(lactic acid). In one or more embodiments, the quench temperature T_{q} may be room temperature (e.g. 20° C. to 22° C.; or 20° C.). The predetermined amount of quench time to get to the quench temperature T_{q} may be 2 minutes or less, in other embodiments, 1 minute or less, and in other embodiments, 30 seconds or less.

During the quenching step, the melt stretched poly(lactic acid) may be held in the stretched state during the quenching. In other embodiments, such as where the quenching occurs at a fast rate of quench, the melt stretched poly(lactic acid) may not need be specifically held in the stretched state because the fast quench will avoid substantial sample contraction.

The storage quenching step generally further includes a step of storing the quenched poly(lactic acid). The storing occurs for a predetermined amount of storage time prior to carrying out said crystallization step. The storing may be on the order of minutes, hours, days, weeks, months, or years. In one or more embodiments, the storing occurs for at least 10 minutes, in other embodiments, for at least 1 hour, in other embodiments, for at least 10 hours, in other embodiments, for at least 1 day, in other embodiments, for at least 5 days, in other embodiments, for at least 1 month, and in other embodiments, for at least 1 year.

The methods disclosed herein may include an amorphizing step. Where present, the amorphizing step generally occurs before the step of melt stretching.

The amorphizing step generally includes heating poly(lactic acid) resin above its melting temperature Tₘ to create a molten poly(lactic acid). The molten poly(lactic acid) is then quenched to an amorphizing temperature Tₐ that is below the glass transition temperature T_{g} of the amorphous poly(lactic acid) resin. The amorphizing step generally serves to avoid crystallization and to maintain an amorphous state.

In one or more embodiments, in the amorphizing step, the step of heating the poly(lactic acid) resin includes heating the poly(lactic acid) resin to a temperature of from 150° C. or more to 225° C. or less, in other embodiments, from 170° C. or more to 210° C. or less, and in other embodiments, from 180° C. or more to 200° C. or less.

In one or more embodiments, in the amorphizing step, the amorphizing temperature Tₐ may be room temperature. In one or more embodiments, in the amorphizing step, the step of quenching the molten poly(lactic acid) includes quenching the molten poly(lactic acid) down to the amorphizing temperature Tₐ (e.g. room temperature) within 4 minutes or less, in other embodiments, within 3 minutes or less, in other embodiments, within 2 minutes or less, in other embodiments, within 1 minute or less, and in other embodiments, within 30 seconds or less.

Embodiments of the present invention include the poly(lactic acid) material made by the method described above. The poly(lactic acid) material made by the method described above may be referred to as cold crystallized, melt stretched PLA (cc-ms-PLA) or cold crystallized, melt stretched PLLA (cc-ms-PLLA) where the PLA includes PLLA.

The mechanical properties of the cc-ms-PLA are generally superior relative to corresponding materials that are not subjected to the method disclosed herein, which may also be referred to as materials made by different, more traditional methods.

The cc-ms-PLA is super tough, optically clear, and heat resistant. In contrast, poly(lactic acid) materials of the prior art (i.e., not made by the present methods) are brittle and opaque in the crystalline form, and have a HDT at 60° C. in non-crystalline form.

In one or more embodiments, the mechanical enhancement of the cc-ms-PLA is preserved at room temperature. In one or more embodiments, the mechanical characteristics (at 100° C.) of the cc-ms-PLA may include a Young's modulus up to 250 MPa. This high stiffness generally indicates that the cc-ms-PLA is space-filled with nanosized crystals, which may also be referred to as having nano-confined crystalline form. Without being bound by any theory, the material system behaves similar to a heavily loaded polymer nanocomposite, with the nanocrystals acting like rigid fillers. The method disclosed herein is believed to suppress formation of large crystallites such as spherulites and to promote nanocrystallization nucleating from the stretched entanglement strands. Such a new crystalline state makes the resulting product super ductile, giving rise to both optical clarity and dimensional stability at high temperatures.

In one or more embodiments, the cc-ms-PLA has an absence of any shrinkage at 120° C. In one or more embodiments, the cc-ms-PLA has a heat distortion temperature (HDT) above 120° C. In one or more embodiments, after 1 hour of annealing at 120° C., the cc-ms-PLA shows indiscernible change in its length.

In one or more embodiments, the stress response of the cc-ms-PLA at 100° C. is higher by a factor of 10 compared to the stress level shown by a material made by a method only including melt-stretching amorphous poly(L-lactic acid) (aPLLA) at 70° C.

The methods herein can be applied using stretch blow molding to make mechanically strong and optically transparent cups and containers holding boiling water. The methods involving biaxial melt stretching generally result in sheets and films of various thickness that are transparent, extraordinarily tough and heat resistant (with HDT >120° C.).

In light of the foregoing, it should be appreciated that the present invention significantly advances the art by providing improved poly(lactic acid)-based materials and methods of making the poly(lactic acid)-based material. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A process for producing poly(lactic acid)-based material, the process comprising:
providing an amorphous poly(lactic acid) resin having a glass transition temperature T_{g} and a crystallization temperature T_{c};
a melt stretching step including
melt stretching the amorphous poly(lactic acid) resin at a melt stretch temperature Tₘₛ,
wherein the amorphous poly(lactic acid) resin is capable of crystallization, and
wherein the Tₘₛ is greater than the glass transition temperature T_{g} of the amorphous poly(lactic acid) resin and less than the crystallization temperature T_{c} of the amorphous poly(lactic acid) resin,
thus providing a melt stretched poly(lactic acid); and
a crystallization step including
providing the melt stretched poly(lactic acid) at a cold crystallization temperature T_{cc} of greater than the glass transition temperature T_{g} of the amorphous poly(lactic acid) resin and less than the crystallization temperature T_{c} of the amorphous poly(lactic acid) resin, and
wherein the melt stretched poly(lactic acid) is at the cold crystallization temperature T_{cc} for a sufficient time t_{cc} to allow for cold crystallization of the melt stretched poly(lactic acid).

2. The process of claim 1, wherein the amorphous poly(lactic acid) resin is a resin selected from the group consisting of poly(L-lactic acid) (PLLA) resin, and resins of copolymers of PLLA and poly(D,L-lactic acid) (PDLLA), and mixtures thereof.

3. The process of claim 2, wherein the amorphous poly(lactic acid) resin includes poly(lactic acid) at an average molecular weight selected from the group consisting of greater than 35 kDa, greater than 50 kDa, greater than 75 kDa, greater than 100 kDa, and greater than 120 kDa.

4. The process of claim 1, wherein, in the melt stretching step, the amorphous poly(lactic acid) resin is stretched uniaxially.

5. The process of claim 4, wherein, in the melt stretching step, the amorphous poly(lactic acid) resin is stretched to a stretch ratio λₘₛ selected from the group consisting of 2 or greater, 2.25 or greater, 2.5 or greater, and 3 or greater.

6. The process of claim 1, wherein, in the melt stretching step, the amorphous poly(lactic acid) resin is stretched biaxially.

7. The process of claim 6, wherein, in the melt stretching step, the amorphous poly(lactic acid) resin is stretched to a stretch ratio λₘₛ selected from the group consisting of 1.5×1.5 or greater, 2×2 or greater, 2.5×2.5 or greater, and 3×3 or greater.

8. The process of claim 1, wherein, in the melting step, the amorphous poly(lactic acid) resin is stretched at a rate at least ten times the dominant chain relaxation rate to achieve molecular stretching.

9. The process of claim 1, wherein Tₘₛ is from 60° C. or more to 105° C. or less.

10. The process of claim 1, wherein T_{cc} is from 65° C. or more to 105° C. or less.

11. The process of claim 1, wherein t_{cc} is 2 minutes or more, wherein Tₘₛ is from 70° C. or more to 90° C. or less, and wherein T_{cc} is from 70° C. or more to 90° C. or less.

12. The process of claim 1, wherein the step of crystallization includes holding the melt stretched poly(lactic acid) in a stretched state at the cold crystallization temperature T_{cc}.

13. The process of claim 1, further comprising a storage quenching step after said melt stretching step and before said crystallization step, the storage quenching step including:
quenching the melt stretched poly(lactic acid) from Tₘₛ to a quench temperature T_{q} below the glass transition temperature T_{g} of the amorphous poly(lactic acid) resin within a predetermined amount of quench time to thereby form a quenched poly(lactic acid); and
storing the quenched poly(lactic acid) of said storage quenching step for a predetermined amount of storage time prior to carrying out said crystallization step.

14. The process of claim 13, wherein the step of quenching includes holding the melt stretched poly(lactic acid) in a stretched state at the quench temperature T_{q}.

15. The process of claim 13, wherein T_{q} is room temperature, wherein the predetermined amount of quench time is 2 minutes or less, and wherein the predetermined amount of storage time is 1 month or more.

16. The process of claim 1, further comprising an amorphizing step, prior to said melt stretching step, the amorphizing step including:
heating poly(lactic acid) resin above its melting temperature Tₘ to create a molten poly(lactic acid); and
quenching the molten poly(lactic acid) to an amorphizing temperature Tₐ below the glass transition temperature T_{g} of the amorphous poly(lactic acid) resin to avoid crystallization and to maintain an amorphous state.

17. The process of claim 16, wherein, in said step of heating the poly(lactic acid) resin, the poly(lactic acid) resin is heated to a temperature of from 170° C. or more to 210° C. or less.

18. The process of claim 16, wherein, in said step of quenching the molten poly(lactic acid), the amorphizing temperature Tₐ is room temperature, and wherein the molten poly(lactic acid) is quenched down to room temperature within 1 minutes.

19. A poly(lactic acid) material made by the process of claim 1.

20. The poly(lactic acid) material of claim 19, wherein the poly(lactic acid) material is optically clear and includes a heat distortion temperature (HDT) above 120° C.
